(19) United States
(12) Patent Application Publication
(10) Pub. No.: US 2023/0393296 A1
(43) Pub. Date: Dec. 7, 2023

(54) ADJACENT WELL DETECTION APPARATUS, METHOD AND SYSTEM

(71) Applicant: CHINA OILFIELD SERVICES LIMITED, Tianjin (CN)

(72) Inventors: Xi LUO, Hebei (CN); Guoyu LI, Hebei (CN); Bo DANG, Hebei (CN); Caihui QIN, Hebei (CN); Jinhai ZHAI, Hebei (CN); Aiyong LI, Hebei (CN); Xizhou YUE, Hebei (CN); Mingxue MA, Hebei (CN); Xinbiao JI, Hebei (CN); Yiyi WANG, Hebei (CN)

(73) Assignee: CHINA OILFIELD SERVICES LIMITED, Tianjin (CN)

(21) Appl. No.: 18/033,960

(22) PCT Filed: Nov. 22, 2021
(86) PCT No.: PCT/CN2021/132123

§ 371 Date: Apr. 26, 2023

(30) Foreign Application Priority Data
Jan. 21, 2021 (CN) 202110083594.7

(51) Int. Cl. G01V 3/10; E21B 47/0228

(52) U.S. Cl. CPC G01V 3/10; E21B 47/0228

(57) ABSTRACT

An adjacent well detection apparatus, method and system. The adjacent well detection apparatus is arranged on a drill collar of a first well. The adjacent well detection apparatus includes a transmitting probe and receiving probes. The apparatus includes: the transmitting probe, configured to generate a primary magnetic field according to a bipolar transient pulse signal applied to the transmitting probe, wherein a change in the primary magnetic field can generate a second magnetic field on a sleeve of an adjacent second well; and the receiving probes, configured to generate an induced electromotive force according to the second magnetic field, wherein the induced electromotive force is used for acquiring relative distance information and orientation information of the adjacent well.

### TECHNICAL FIELD

Embodiments of the present application relate to, but are not limited to, the field of logging, in particular to an apparatus for detecting an adjacent well, a method for detecting an adjacent well, and a system thereof.

### BACKGROUND

Cluster wells and infill wells have their advantages in aspects of an oilfield construction and an oil extraction, but with an increasing number of wellheads in a single platform, a risk of a borehole collision is increasing during drilling. An unexpected borehole cross-collision will bring a potential and even disastrous consequence to oil companies and the environment. In order to reduce the occurrence of such accidents, some borehole anti-collision technologies are put forward.

The document “Anti-Collision Technology and Application of Infill Wells in a Cluster Well Group, 2018” and the patent “Optimization Method of Drilling Sequence in an Offshore Cluster Well Group (CN201510611700.9)” adopt an anti-collision scanning method, in which borehole trajectory errors are counted so that an error ellipse of the present well fitted by it does not intersect with a trajectory error ellipse of an adjacent well, to avoid a collision. For the anti-collision scanning method, if there are factors, such as that a relatively large error appearing in trajectory while drilling data due to cases such as magnetic interference or the like, a low precision, distortion, or missing of a trajectory parameter of the adjacent well, and too idealistic trajectory fitting method, etc., a fitted borehole trajectory will deviate from an actual trajectory, so that a collision occurs.

The document “Analysis and Visualization of Borehole Cross-Collision Risk, 2018” and the patent “An Anti-Collision Early Warning Method for Upper Vertical Section of Cluster Well Based on Magnetic Field Detection of Casing String in Adjacent Wells (CN201711416109.3)” use a rapid tool surface measurement value of MWD to identify an adjacent casing magnetic interference phenomenon and a borehole cross-collision risk, which can not only improve an identification probability of the borehole cross-collision risk, but also find the borehole cross-collision risk as early as possible, and estimate relative positions of casing strings in adjacent wells, providing an important support for an anti-collision around a barrier construction. For a cross-collision probability analysis method, a trajectory of a well body is monitored by an inclinometer, and then a relative distance is calculated according to the trajectory. This indirect estimation for the distance depends on the accuracy of inclinometer data to a great extent, and a measurement of a magnetic inclinometer is easily affected by an external magnetic field source, especially the casings of adjacent wells. Therefore, this method has a relatively large error, and is often fatal in short-distance shallow anti-collision.

### SUMMARY

The following is a summary of the subject matter described in detail herein. This summary is not intended to limit the protection scope of the claims.

The present disclosure provides an apparatus for detecting an adjacent well, a method for detecting an adjacent well, and a system thereof, wherein the apparatus for detecting an adjacent well can directly obtain relative distance information and azimuth information of the adjacent well by using electromagnetic signals.

In the first aspect, the present disclosure provides an apparatus for detecting an adjacent well, disposed on a drill collar of a first well; wherein, the apparatus for detecting an adjacent well includes a transmitting probe and a receiving probe; and the apparatus includes the transmitting probe, configured to generate a primary magnetic field according to a bipolar transient pulse signal applied to the present transmitting probe; wherein a change of the primary magnetic field is capable of generating a second magnetic field on a casing of an adjacent second well; and the receiving probe, configured to generate an induced electromotive force according to the second magnetic field, wherein, the induced electromotive force is used for obtaining distance information and azimuth information of the adjacent well.

In an exemplary embodiment, the transmitting probe is a coil wound on the drill collar; a normal direction of the coil wound on the drill collar is parallel to an axial direction of the drill collar.

In an exemplary embodiment, the receiving probe is a transverse coil disposed on the surface of the drill collar; and the coil is perpendicular to the axial direction of the drill collar.

In an exemplary embodiment, the receiving probe includes one or more pairs of receiving probes; wherein, each pair of receiving probes is symmetrically installed at two ends of the transmitting probe.

In an exemplary embodiment, the transmitting probe and the receiving probe include a soft magnetic material.

In the second aspect, the present disclosure also provides a method for detecting an adjacent well, wherein the apparatus for detecting an adjacent well described in any one of the above embodiments is disposed on the drill collar of the first well to be detected, and the method for detecting an adjacent well includes: applying a bipolar transient pulse signal to the transmitting probe in the apparatus for detecting an adjacent well when the drill collar of the first well rotates uniformly; generating, by the transmitting probe, a primary magnetic field through being excited with the bipolar transient pulse signal; wherein a change of the primary magnetic field is capable of generating a second magnetic field on the casing of the adjacent second well; generating, by the receiving probe in the apparatus for detecting the adjacent well according to the second magnetic field, the induced electromotive force; and obtaining the relative distance information and the azimuth information of the second well through an inversion of the induced electromotive force.

In an exemplary embodiment, the change of the primary magnetic field is capable of generating the second magnetic field on the casing of the adjacent second well, including: when a forward pulse of the bipolar transient pulse signal excites the transmitting probe, generating, by the transmitting probe, the primary magnetic field in a space; and when the forward pulse is turned off, generating an annular induced current and the second magnetic field on the casing of the adjacent second well.

In an exemplary embodiment, the induced electromotive force includes:

$${U}_{R} = - i ω μ {N}_{R} {\int }_{S} {H}_{z}^{′} dS$$

In the above expression of the induced electromotive force, U_{R} represents the induced electromotive force, ω represents a signal angular frequency, N_{R} represents the number of turns of a coil of the receiving probe, and S represents an effective area of the coil of the receiving probe.

In an exemplary embodiment, obtaining the distance information and the azimuth information of the second well through an inversion of the probing signals includes: performing differential amplification processing on an electromotive force generated by each pair of receiving probes; and obtaining the distance information and the azimuth information of the second well through an inversion of a signal on which the differential amplification processing has been performed.

In the third aspect, the present disclosure also provides a system for detecting an adjacent well, which is applied in an adjacent well detection of cluster wells, and includes the apparatus for detecting an adjacent well as described in any of the above embodiments, a ground processing module, and a signal module; wherein, the signal module is configured to apply a bipolar transient pulse signal to the transmitting probe in the adjacent well detection; the apparatus for detecting an adjacent well is configured to generate an electromotive force according to the bipolar transient pulse signal; and the ground processing module is configured to obtain distance information and azimuth information of the second well through an inversion of the electromotive force.

In an exemplary embodiment, the apparatus for detecting an adjacent well includes the transmitting probe. The transmitting probe is a coil wound on the drill collar; and a normal direction of the coil wound on the drill collar is parallel to an axial direction of the drill collar.

In an exemplary embodiment, the apparatus for detecting an adjacent well further includes the receiving probe. The receiving probe is a transverse coil disposed on a surface of the drill collar; and the coil is perpendicular to an axial direction of the drill collar; and the receiving probe includes one or more pairs of receiving probes; wherein, each pair of receiving probes is symmetrically installed at two ends of the transmitting probe.

In an exemplary embodiment, the change of the primary magnetic field is capable of generating the second magnetic field on the casing of the adjacent second well, including: when a forward pulse of the bipolar transient pulse signal excites the transmitting probe, generating, by the transmitting probe, the primary magnetic field in space; and when the forward pulse is turned off, generating an annular induced current and the second magnetic field on the casing of the adjacent second well.

In an exemplary embodiment, the induced electromotive force includes:

$${U}_{R} = - i ω μ {N}_{R} {\int }_{S} {H}_{z}^{′} dS$$

In the above expression of the induced electromotive force, U_{R} represents the induced electromotive force, ω represents a signal angular frequency, N_{R} represents the number of turns of a coil of the receiving probe, and S represents an effective area of the coil of the receiving probe.

In an exemplary embodiment, obtaining relative distance information and the azimuth information of the second well through an inversion of the induced electromotive force includes: performing differential amplification processing on an induced electromotive force generated by each pair of receiving probes; and obtaining the distance information and the azimuth information of the second well through an inversion of a signal on which the differential amplification processing has been performed.

It is set that other aspects will become apparent after reading and understanding the accompanying drawings and detailed descriptions.

### BRIEF DESCRIPTION OF DRAWINGS

The accompanying drawings are used to provide a further understanding of the technical solutions of the present application, and constitute a part of the specification. They are used together with embodiments of the present application to explain the technical solutions of the present application, and do not constitute a restriction on the technical solutions of the present application.

FIG. 1 is a schematic diagram of an apparatus for detecting an adjacent well of an embodiment of the present disclosure.

FIG. 2 is a schematic diagram of a location of an apparatus for detecting an adjacent well in some exemplary embodiments.

FIG. 3 is a magnetic field distribution of a transmitting probe in some exemplary embodiments.

FIG. 4 is a schematic diagram of a transmitting signal waveform in some exemplary embodiments.

FIG. 5 is a magnetic field distribution of a receiving probe in some exemplary embodiments.

FIG. 6 is a schematic diagram of a received signal waveform in some exemplary embodiments.

FIG. 7 is a schematic diagram of a front view and a top view of a drill collar rotated while drilling in some exemplary embodiments.

FIG. 8 is a flowchart of a method for detecting an adjacent well of an embodiment of the present disclosure.

FIG. 9 is a system for detecting an adjacent well of an embodiment of the present disclosure.

FIG. 10 is a probing flow of a system for detecting an adjacent well in some exemplary embodiments.

FIG. 11 is a received response after differential amplification processing is performed when dual targets have the same distance from a probe in some exemplary embodiments.

### DETAILED DESCRIPTION

Hereinafter, embodiments of the present application will be described in detail with reference to the accompanying drawings. It needs to be noted that the embodiments in the present application and features in the embodiments may be combined with each other arbitrarily if there is no conflict.

Acts illustrated in the flowchart of the accompanying drawings may be performed in a computer system such as a set of computer executable instructions. And although a logical sequence is illustrated in the flowchart, in some cases acts illustrated or described may be performed in a different sequence from that herein.

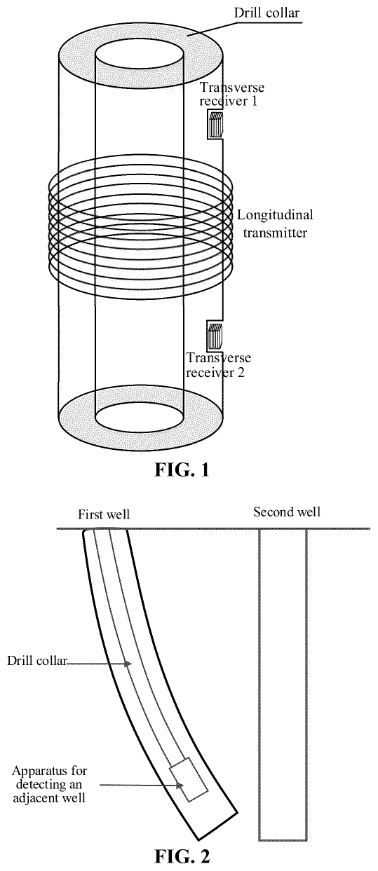

An embodiment of the present disclosure provides an apparatus for detecting an adjacent well, as shown in FIG. 1, wherein the apparatus for detecting the adjacent well is disposed on a drill collar of a first well; and the apparatus for detecting the adjacent well includes a transmitting probe 110 and a receiving probe 120; and the apparatus includes: the transmitting probe 110, configured to generate a primary magnetic field according to a bipolar transient pulse signal applied to the present transmitting probe; wherein a change of the primary magnetic field is capable of generating a second magnetic field on a casing of an adjacent second well; and the receiving probe 120, configured to generate an induced electromotive force according to the second magnetic field, wherein, the induced electromotive force is used for obtaining relative distance information and azimuth information of the adjacent well.

In the present embodiment, the apparatus for detecting the adjacent well is disposed in the first well, and a schematic diagram of positions of the first well and the second well is shown in FIG. 2.

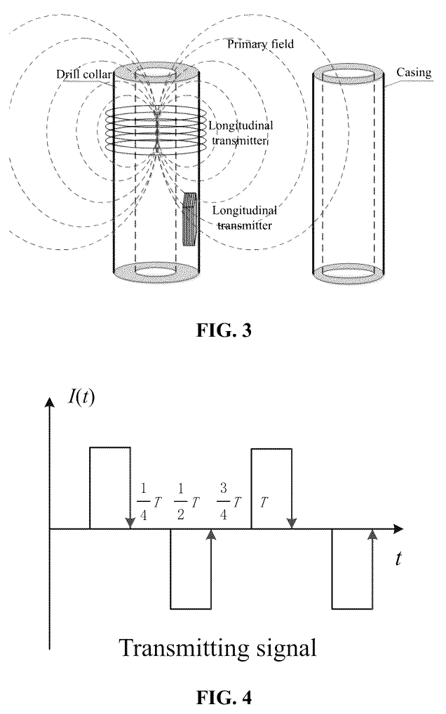

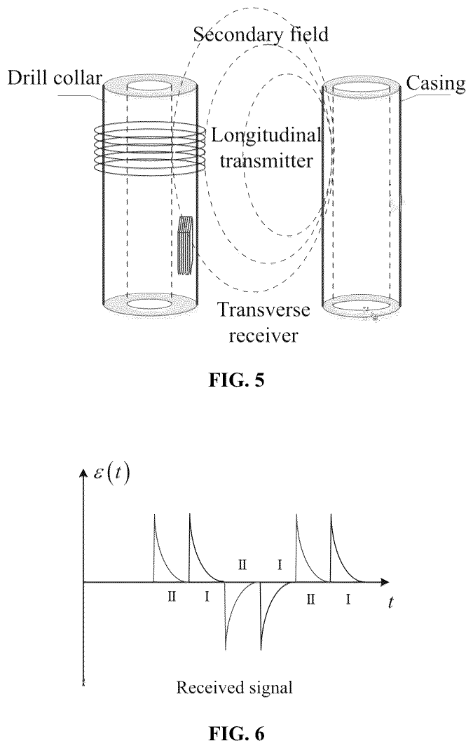

By applying a bipolar transient pulse signal to the transmitting probe, when a forward pulse is outputted, a primary magnetic field is generated in a space, with a magnetic field distribution of the transmitting probe as shown in FIG. 3 and a waveform of a transmit signal of the transmitting probe as shown in FIG. 4; when the forward pulse is turned off, the magnetic field suddenly disappears, a relatively large annular induced current and a secondary magnetic field will be generated on a casing of the adjacent well. The induced current and the secondary magnetic field will gradually decay, and the secondary magnetic field in decay will generate an induced electromotive force when passing through a receiving coil, with a magnetic field distribution of the receiving probe as shown in FIG. 5 and a waveform of a signal received by the receiving probe as shown in FIG. 6.

In an exemplary embodiment, an implementation of obtaining relative distance information and azimuth information of the adjacent well using the induced electromotive force may be as follows.

A model for probing transient electromagnetic of cluster wells is established, and a magnetic vector A is introduced. Since the transmitting probe, that is a transmitting coil, is wound around the drill collar, it cannot serve as a magnetic dipole for calculation, but may be regarded as an equivalent current loop. The current loop is composed of electric dipoles. Then a vector potential generated by a segment of electric dipole Idl located in a uniform space R=(r′, φ′, 0) at any point R=(r, φ, z) in the space satisfies homogeneous and non-homogeneous Helmholtz equations:

∇²A+k²A=−I_{T}dl (1)

∇²Aⱼ+kⱼ²Aⱼ=0 j≠2 (2)

In the above formulas (1) and (2), A is a magnetic vector, k is a wave number, I_{T} is an intensity of a transmitting current, and dl is an arc length of an electric dipole. By solving the formula (1), a vector potential in a direction of e_{Φ} generated by the transmitting coil in a space may be obtained as follows:

$${A}_{φ} = \{ \begin{matrix}\frac{{N}_{T} {I}_{T} {r}_{0}}{π} {\int }_{0}^{∞} {K}_{1} ( xr ) {I}_{1} ( {xr}_{0} ) cos λ zd λ , r < {r}_{0} \\ \frac{{N}_{T} {I}_{T} {r}_{0}}{π} {\int }_{0}^{∞} {K}_{1} ( {xr}_{0} ) {I}_{1} ( xr ) cos λ zd λ , r < {r}_{0}\end{matrix} \qquad ( 3 )$$

In the above formula (3), A_{φ} is the vector potential in the direction of e_{Φ}, N_{T} is a number of turns of the transmitting coil, I_{T} is the intensity of the transmitting current, r₀ is a radius of the drill collar, and I₁(⋅) and K₁(⋅) are Order 1 complex argument Bessel functions of a first kind and a second kind, respectively, x and λ are introduced variables, and satisfy x²=λ²−k², and z is a distance between the transmitting coil and the receiving coil. According to a relationship between a magnetic field and a vector potential, H=∇×A, a magnetic field intensity of the primary magnetic field generated by the transmitting coil may be obtained as follows:

$${H}_{z} = \{ \begin{matrix}- \frac{{N}_{T} {I}_{T} {r}_{0}}{π} {\int }_{0}^{∞} {xK}_{0} ( xr ) {I}_{1} ( {xr}_{0} ) cos λ zd λ , r < {r}_{0} \\ \frac{{N}_{T} {I}_{T} {r}_{0}}{π} {\int }_{0}^{∞} {xK}_{1} ( {xr}_{0} ) {I}_{1} ( xr ) cos λ zd λ , r < {r}_{0}\end{matrix} \qquad ( 4 )$$

In the above formula (4), I₀(⋅) and K₀(⋅) are Order 0 complex argument Bessel functions of a first kind and a second kind, respectively. By solving the formula (2), a magnetic field intensity of the secondary magnetic field generated by the transmitting coil in each layer of dielectric may be obtained as follows:

$${H}_{z}^{′} = \frac{{N}_{T} {I}_{T} {r}_{0}}{π} {\int }_{0}^{∞} {x}_{1} {A}_{1} {I}_{0} ( {x}_{1} r ) cos λ zd λ \qquad ( 5 )$$

In the above formula (5), A₁ is an undetermined coefficient, which may be solved according to a boundary condition of each layer of dielectric.

In an actual under well detection process, the induced electromotive force is usually used to measure a under well electromagnetic response. Therefore, an induced electromotive force of a secondary field received by a transverse receiving coil may be expressed as follows:

$${U}_{R} = - i ω μ {N}_{R} {\int }_{S} {H}_{z}^{′} dS \qquad ( 6 )$$

In the above formula (6), ω represents a signal angular frequency, N_{R} represents the number of turns of a coil in the receiving probe, and S represents an effective area of the coil in the receiving probe.

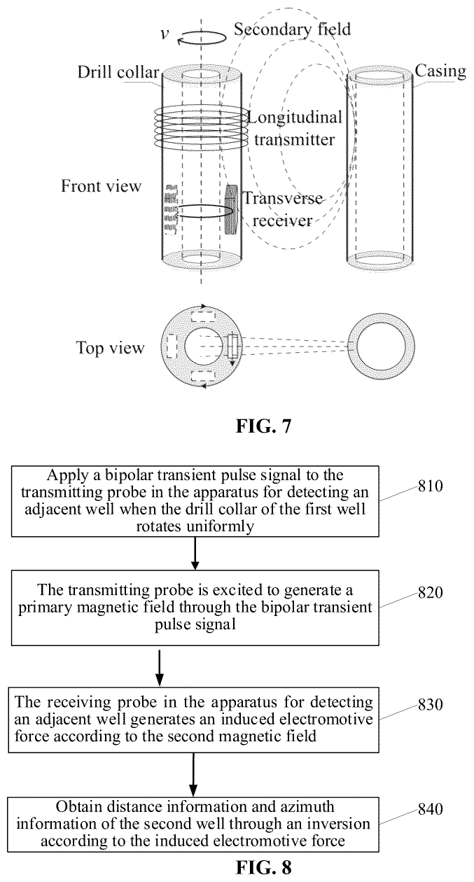

Based on the above relationship formula, the apparatus for detecting the adjacent well is obtained, and is adopted to probe a distance and an azimuth between cluster wells. During a measurement, the drill collar of the first well is in a rotating state, and a transverse receiving probe may be used to achieve multi-component probing. A front view and a top view of the drill collar rotated while drilling are shown in FIG. 7.

In addition, the rotation of the drill collar makes the receiving probe cut a secondary field, and a final time domain response is the coupling of an electromotive force induced by the secondary field and an electromotive force generated by cutting the secondary field through rotating, that is,

$${U}_{R} ( t ) = μ \frac{\partial S ( t ) {H}_{z}^{′} ( t )}{\partial t} \qquad ( 7 )$$

In the above formula (7), U_{R}(t) represents a relationship of the electromotive force with observation time, and t represents observation time.

In an exemplary embodiment, the transmitting probe is a coil wound on the drill collar; wherein, a normal direction of the coil wound on the drill collar is parallel to an axial direction of the drill collar.

In an exemplary embodiment, the receiving probe is a transverse coil disposed on a surface of the drill collar; the coil is perpendicular to an axial direction of the drill collar; wherein, the receiving probe may be a transverse coil disposed in a groove opened on the surface of the drill collar; and the coil is perpendicular to the axial direction of the drill collar.

In an exemplary embodiment, the receiving probe includes one or more pairs of receiving probes; wherein, each pair of receiving probes is symmetrically installed at two ends of the transmitting probe. In the present embodiment, the receiving probe may include a pair of transverse probes, i.e., two transverse probes, one of which is close to a measured casing, and the other is away from the measured casing, so as to ensure that distances from the two transverse receiving probes to the measured casing (the measured casing refers to the casing of the adjacent well) are different, and a radial ambiguity may be eliminated after differential processing is performed on received signals thereof, which may further improve a directional accuracy. On this basis, by determining amplitude values of two transverse received responses, a relative gesture between the casing of the adjacent well and a positive artesian well may be determined. If the two wells are in a parallel posture, the two transverse received responses may still be combined to improve an overall signal-to-noise ratio of a cluster well anti-collision system. The receiving probe may also include multiple pairs, the multiple pairs of receiving probes may be disposed to add a symmetrical transverse receiving probe at intervals of a longitudinal distance.

In an exemplary embodiment, the transmitting probe and the receiving probe include a soft magnetic material, wherein the soft magnetic material may enhance the intensity of a signal.

An embodiment of the present disclosure provides a method for detecting an adjacent well, as shown in FIG. 8, which is applied to the apparatus for detecting the adjacent well described in the above embodiment disposed on the drill collar of the first well, a schematic diagram of a position thereof is shown in FIG. 2, and the method for detecting the adjacent well includes the following acts 810 to 840.

In the act 810, a bipolar transient pulse signal is applied to a transmitting probe in the apparatus for detecting the adjacent well when the drill collar of the first well rotates uniformly.

In the act 820, the transmitting probe is excited by the bipolar transient pulse signal to generate a primary magnetic field; wherein a change of the primary magnetic field is capable of generating a second magnetic field on a casing of an adjacent second well.

In the act 830, a receiving probe in the apparatus for detecting the adjacent well generates an induced electromotive force according to the second magnetic field.

In the act 840, distance information and azimuth information of the second well are obtained by an inversion of the induced electromotive force.

In an exemplary embodiment, the change of the primary magnetic field is capable of generating the second magnetic field on the casing of the adjacent second well, including: when a forward pulse of the bipolar transient pulse signal excites the transmitting probe, the transmitting probe generates a primary magnetic field in a space; and when the forward pulse is turned off, an annular induced current and a secondary magnetic field are generated on the casing of the adjacent second well.

In an exemplary embodiment, the induced electromotive force includes:

$${U}_{R} = - i ω μ {N}_{R} {\int }_{S} {H}_{z}^{′} dS$$

In the above formula, U_{R} represents the induced electromotive force, ω represents a signal angular frequency, N_{R} represents the number of turns of a coil of the receiving probe, and S represents an effective area of the coil of the receiving probe.

In an exemplary embodiment, obtaining, by an inversion of the probing signal, distance information and azimuth information of the second well includes: differential amplification processing is performed on a probing signal received by each pair of receiving probes; and the distance information and the azimuth information of the second well are obtained by an inversion of a signal on which the differential amplification processing has been performed.

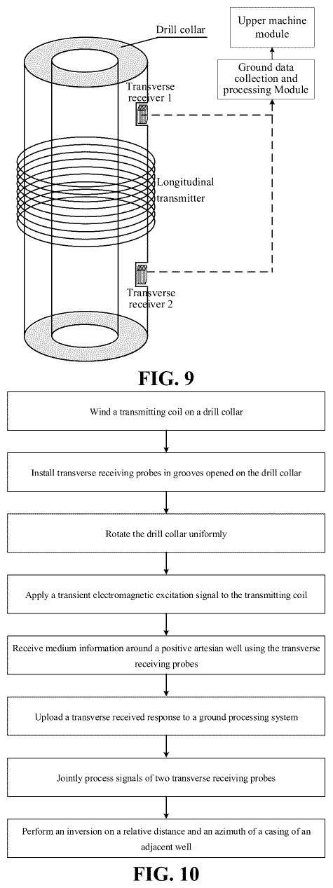

An embodiment of the present disclosure provides a system for detecting an adjacent well, as shown in FIG. 9, which is applied in an adjacent well detection of cluster wells, and includes the apparatus for detecting the adjacent well as described in any one of the above embodiments, a ground processing module, and a signal module. The signal module is configured to apply a bipolar transient pulse signal to a transmitting probe in the adjacent well detection; wherein, the bipolar transient pulse signal is shown in FIG. 4. The apparatus for detecting the adjacent well is configured to generate an electromotive force according to the bipolar transient pulse signal. The ground processing module is configured to obtain distance information and azimuth information of a second well by an inversion of the electromotive force. The ground processing module includes: an upper machine module and a ground data collection and processing module.

In an exemplary embodiment, the apparatus for detecting the adjacent well includes: the transmitting probe; wherein the transmitting probe is a coil wound on a drill collar; and a normal direction of the coil wound on the drill collar is parallel to an axial direction of the drill collar.

In an exemplary embodiment, the apparatus for detecting the adjacent well further includes: a receiving probe; wherein the receiving probe is a transverse coil disposed on a surface of the drill collar; and the coil is perpendicular to an axial direction of the drill collar; and the receiving probe includes one or more pairs of receiving probes; wherein, each pair of receiving probes is symmetrically installed at two ends of the transmitting probe.

In an exemplary embodiment, the change of the primary magnetic field is capable of generating the second magnetic field on the casing of the adjacent second well, including: when a forward pulse of the bipolar transient pulse signal excites the transmitting probe, the transmitting probe generates a primary magnetic field in a space; and when the forward pulse is turned off, an annular induced current and the second magnetic field are generated on the casing of the adjacent second well.

In an exemplary embodiment, the induced electromotive force includes:

$${U}_{R} = - i ω μ {N}_{R} {\int }_{S} {H}_{z}^{′} dS$$

In the above expression of the induced electromotive force, U_{R} represents the induced electromotive force, to represents a signal angular frequency, N_{R} represents the number of turns of the coil of the receiving probe, and S represents an effective area of the coil of the receiving probe.

In an exemplary embodiment, obtaining, by an inversion of the induced electromotive force, relative distance information and azimuth information of a second well includes: differential amplification processing is performed on an induced electromotive force generated by each pair of receiving probes; and the distance information and the azimuth information of the second well are obtained by an inversion of a signal on which the differential amplification processing has been performed.

The following is an example to illustrate a probing flow of a system for detecting an adjacent well, as shown in FIG. 10.

In act 1, a longitudinal transmitting coil is wound on a drill collar.

In act 2, two transverse receiving probes are installed in grooves opened on the drill collar, and a distance is arranged between the two probes, which are located at two ends of the transmitting coil.

In act 3, the drill collar is rotated uniformly.

In act 4, a transient electromagnetic excitation signal is applied to the transmitting coil during the rotation of the drill collar.

In act 5, medium information around a positive artesian well is probed by using the two transverse receiving probes.

In act 6, a transverse received signal is transmitted to the ground processing module by means of a transmission while drilling system.

In act 7, signals of two transverse receiving probes are jointly processed.

In act 8, an inversion is performed on a relative distance and an azimuth of a casing of an adjacent well.

Adopting the above system for detecting an adjacent well, a relative distance and an azimuth of an adjacent well in cluster wells may be obtained accurately and directly.

The above embodiments are described below with an example.

Taking a probe structure of “one transmitter and two receivers” as an example, a performance for probing a distance of an active borehole anti-collision tool while drilling is verified. A rotating aluminum tube on a non-magnetic support is used to simulate the drill collar, and a combination of two 7-inch standard casings is adopted to simulate detected wells (two targets, one on the left and one on the right, placed on the ground).

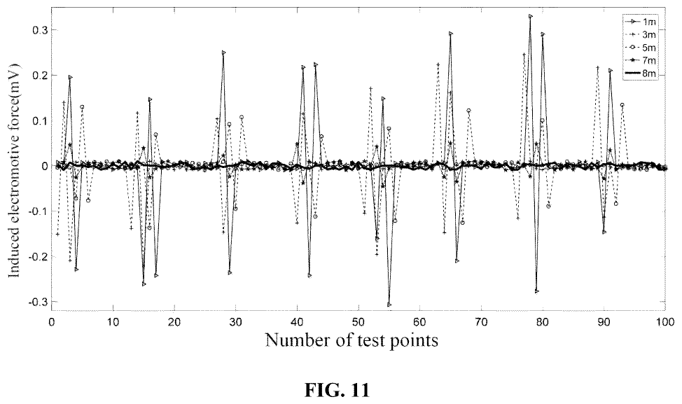

Distances between the two targets and the probe are the same. Relative distances between the probe and the two targets are set to 1 m, 3 m, 5 m, 7 m, and 9 m sequentially, and probing is performed during the rotation of the drill collar. The performance for probing a distance of the apparatus for detecting an adjacent well is analyzed by performing the differential amplification processing on received responses of the two transverse receiving probes. When distances between the two targets and the probe are the same, received responses on which the differential amplification processing has been performed are shown in FIG. 11.

As can be seen from FIG. 11, although a combination of “one transmitter and two receivers” transient electromagnetic probes can obtain a relatively ideal distance probing capability, when distances between the two targets and the probe are 8 m, since relative distances are relatively large, an amplitude of a received signal is limited, and a useful signal is almost completely submerged in the noise, even if differential amplification processing is performed on signals of the two receiving probes, it is impossible to distinguish the two targets. Limited by a test condition, the maximum distance that can be probed by the apparatus for detecting an adjacent well is not less than 7 m at present, and a distance accuracy is 5%. However, in an actual anti-collision probing process of cluster wells, a volume of the casing of the adjacent well is relatively large, and a probing distance of the system for detecting an adjacent well will be greatly improved if an equal proportional conversion is made according to sizes of probes, casings, and the like used in a current test.

The system for detecting an adjacent well based on a transient electromagnetic signal designed in this example, adopting a probe structure of one longitudinal transmitter and two transverse receivers, during the rotation of the drill collar, uses transverse receiving probes to actively probe a secondary eddy current field generated by a transmitting signal on the casing of the adjacent well, and jointly processes responses of two transverse receiving probes, which can perform a high-precision inversion on a distance between the positive artesian well and the casing of the adjacent well. In virtue of the rotation of the drill collar, multi-component under well probing can be achieved by using the transverse receiving probes, which is beneficial to more accurate positioning of the casing of the adjacent well.

In order to improve the probing performance of the system for detecting an adjacent well based on the transient electromagnetic signal, the number of transverse receiving probes may be appropriately increased, and multiple transverse receivers contain more under well casing information. However, with the increase of the number of receiving probes, the number of grooves opened on the drill collar increases, which will also have corresponding impacts on gravity and stiffness of the drill collar; in addition, a distribution, a geometric parameter, and a power of the longitudinal transmitting coil will also have a direct impact on a response of the transverse receiving probe. Therefore, in order to ensure the distribution of transverse receiving probes under a certain probing performance to not have a serious impact on a probing while drilling system, it needs to jointly optimize sizes, winding parameters, spacings, and installation angles of the longitudinal transmitting probe and the transverse receiving probes.

Those of ordinary skill in the art can appreciate that all or some of the acts in the above disclosed method, systems, functional modules/units in apparatuses may be implemented as software, firmware, hardware, and appropriate combinations thereof. In hardware embodiments, a division between functional modules/units mentioned in the above description does not necessarily correspond to a division of physical components; for example, a physical component may have multiple functions, or a function or an act may be performed cooperatively by several physical components. Some or all of the components may be implemented as software executed by a processor, such as a digital signal processor or a microprocessor, or as hardware, or as an integrated circuit, such as an application specific integrated circuit. Such software may be distributed on a computer-readable medium, which may include a computer storage medium (or a non-transient medium) and a communication medium (or a transient medium). As is well known to those of ordinary skill in the art, the term computer storage medium includes volatile and non-volatile, removable and non-removable media implemented in any method or technique for storing information (such as computer-readable instructions, data structures, program modules, or other data). Computer storage media include, but are not limited to, RAM, ROM, EEPROM, a flash memory, or another memory technology, CD-ROM, a digital versatile disk (DVD), or another optical disk storage, a magnetic cartridge, a magnetic tape, a magnetic disk storage or another magnetic storage apparatus, or any other medium that may be configured to store desired information and may be accessed by a computer. In addition, it is well known to those of ordinary skill in the art that the communication medium typically contains computer readable instructions, data structures, program modules, or other data in modulated data signals such as carrier waves or another transmission mechanism, and may include any information delivery medium.

1. An apparatus for detecting an adjacent well, disposed on a drill collar of a first well; wherein the apparatus for detecting an adjacent well comprises a transmitting probe and a receiving probe;
the transmitting probe is configured to generate a primary magnetic field according to a bipolar transient pulse signal applied to the present transmitting probe; wherein a change of the primary magnetic field is capable of generating a second magnetic field on a casing of an adjacent second well; and
the receiving probe is configured to generate an induced electromotive force according to the second magnetic field, wherein, the induced electromotive force is used for obtaining relative distance information and azimuth information of the adjacent well.

2. The apparatus for detecting an adjacent well of claim 1, wherein the transmitting probe is a coil wound on the drill collar; and a normal direction of the coil wound on the drill collar is parallel to an axial direction of the drill collar.

3. The apparatus for detecting an adjacent well of claim 1, wherein the receiving probe is a transverse coil disposed on a surface of the drill collar; and the coil is perpendicular to an axial direction of the drill collar.

4. The apparatus for detecting an adjacent well of claim 3, wherein the receiving probe comprises one or more pairs of receiving probes; wherein, each pair of receiving probes is symmetrically installed at two ends of the transmitting probe.

5. The apparatus for detecting an adjacent well of claim 4, wherein the transmitting probe and the receiving probe comprise a soft magnetic material.

6. A method for detecting an adjacent well, wherein the apparatus for detecting an adjacent well of claim 1 is disposed on the drill collar of the first well to be detected, and the method for detecting an adjacent well comprises:
applying a bipolar transient pulse signal to the transmitting probe in the apparatus for detecting an adjacent well when the drill collar of the first well rotates uniformly;
generating, by the transmitting probe, a primary magnetic field through being excited with the bipolar transient pulse signal; wherein a change of the primary magnetic field is capable of generating a second magnetic field on the casing of the adjacent second well;
generating, by the receiving probe in the apparatus for detecting the adjacent well according to the second magnetic field, the induced electromotive force; and
obtaining the relative distance information and the azimuth information of the second well through an inversion of the induced electromotive force.

7. The method for detecting an adjacent well of claim 6, wherein the change of the primary magnetic field is capable of generating the second magnetic field on the casing of the adjacent second well, comprising:
when a forward pulse of the bipolar transient pulse signal excites the transmitting probe, generating, by the transmitting probe, the primary magnetic field in a space; and when the forward pulse is turned off, generating an annular induced current and the second magnetic field on the casing of the adjacent second well.

8. The method for detecting an adjacent well of claim 7, wherein the induced electromotive force is:
$${U}_{R} = - i ω μ {N}_{R} {\int }_{S} {H}_{z}^{′} dS$$
in the above expression of the induced electromotive force, U_{R} represents the induced electromotive force, ω represents a signal angular frequency, N_{R} represents the number of turns of a coil of the receiving probe, and S represents an effective area of the coil of the receiving probe.

9. The method for detecting an adjacent well of claim 8, wherein the obtaining the relative distance information and the azimuth information of the second well through an inversion of the induced electromotive force comprises:
performing differential amplification processing on an induced electromotive force generated by each pair of receiving probes; and
obtaining the distance information and the azimuth information of the second well through an inversion of a signal on which the differential amplification processing has been performed.

10. A system for detecting an adjacent well, which is applied in an adjacent well detection of cluster wells, comprising the apparatus for detecting an adjacent well of claim 1, a ground processing module, and a signal module; wherein,
the signal module is configured to apply a bipolar transient pulse signal to the transmitting probe in the apparatus for detecting an adjacent well, of the first well;
the apparatus for detecting an adjacent well is configured to generate a primary magnetic field according to the bipolar transient pulse signal; wherein a change of the primary magnetic field is capable of generating a second magnetic field on the casing of the adjacent second well; and generate an induced electromotive force according to the second magnetic field; and
the ground processing module is configured to obtain the distance information and the azimuth information of the second well through an inversion of the induced electromotive force.

11. The system for detecting an adjacent well of claim 10, wherein the apparatus for detecting an adjacent well comprises: the transmitting probe;
the transmitting probe is a coil wound on the drill collar; and a normal direction of the coil wound on the drill collar is parallel to an axial direction of the drill collar.

12. The system for detecting an adjacent well of claim 10, wherein the apparatus for detecting an adjacent well further comprises: the receiving probe;
the receiving probe is a transverse coil disposed on a surface of the drill collar; and the coil is perpendicular to an axial direction of the drill collar; and
the receiving probe comprises one or more pairs of receiving probes; wherein, each pair of receiving probes is symmetrically installed at two ends of the transmitting probe.

13. The system for detecting an adjacent well of claim 10, wherein the change of the primary magnetic field is capable of generating the second magnetic field on the casing of the adjacent second well, comprising:
when a forward pulse of the bipolar transient pulse signal excites the transmitting probe, generating, by the transmitting probe, the primary magnetic field in a space; and when the forward pulse is turned off, generating an annular induced current and the second magnetic field on the casing of the adjacent second well.

14. The system for detecting an adjacent well of claim 13, wherein the induced electromotive force is:
$${U}_{R} = - i ω μ {N}_{R} {\int }_{S} {H}_{z}^{′} dS$$
in the above expression of induced electromotive force, U_{R} represents the induced electromotive force, ω represents a signal angular frequency, N_{R} represents the number of turns of a coil of the receiving probe, and S represents an effective area of the coil of the receiving probe.

15. The system for detecting an adjacent well of claim 14, wherein obtaining relative distance information and the azimuth information of the second well through an inversion of the induced electromotive force comprises:
performing differential amplification processing on an induced electromotive force generated by each pair of receiving probes; and
obtaining the distance information and the azimuth information of the second well through an inversion of a signal on which the differential amplification processing has been performed.
